(19) United States
(12) Patent Application Publication
(10) Pub. No.: US 2022/0127484 A1
(43) Pub. Date: Apr. 28, 2022

(54) PRINT MEDIA

(71) Applicant: Hewlett-Packard Development Company, L.P., Spring, TX (US)

(72) Inventors: Beverly Chou, San Diego, CA (US); Tao Chen, San Diego, CA (US); Xulong Fu, San Diego, CA (US); Xiaoqi Zhou, San Diego, CA (US)

(73) Assignee: Hewlett-Packard Development Company, L.P., Spring, TX (US)

(21) Appl. No.: 17/413,995

(22) PCT Filed: Jul. 12, 2019
(86) PCT No.: PCT/US2019/041691

§ 371 Date: Jun. 15, 2021

(51) Int. Cl. C09D 11/54; D21H 19/82; D21H 17/68; D21H 17/67; D21H 19/38; D21H 19/40; D21H 19/58; D21H 19/60; D21H 19/62; C09D 11/023; C09D 11/033; C09D 11/037; C09D 11/108; C09D 11/322; B41M 5/50; B41M 5/00

(52) U.S. Cl. CPC C09D 11/54; B41M 5/0023; D21H 17/68; D21H 17/675; D21H 19/385; D21H 19/40; D21H 19/58; D21H 19/60; D21H 19/62; C09D 11/023; C09D 11/033; C09D 11/037; C09D 11/108; C09D 11/322; B41M 5/502; D21H 19/822

(57) ABSTRACT

The present disclosure is drawn to a base paper substrate that is cellulose-based and an ink-receiving layer on the base paper substrate. The ink-receiving layer, for example, includes a metal salt, inorganic particulates, a polymeric binder, and an emulsifier including a hydroxylated saturated hydrocarbon block including from 6 to 24 carbon atoms and a hydroxyl group and further includes a polyalkylene oxide block including form 10 to 35 polyalkylene oxide units selected from polyethylene oxide, polypropylene oxide, or a combination thereof.

### BACKGROUND

There are several reasons that inkjet printing has become a popular way of recording images on various medium surfaces, particularly paper. Some of these reasons include low printer noise and capability of high-speed recording (or printing), reduced job turnaround time, improved competitiveness in the context of commercial printing, or the like. High speed printing applications, for example, can provide many benefits. Providing good ink absorption and/or fast dry time while retaining good gloss is a combination that is useful in the context of high speed printing, for example.

### BRIEF DESCRIPTION OF THE DRAWINGS

FIG. 1 is a schematic cross-sectional view of an example print medium including a base paper substrate and an ink-receiving layer in accordance with examples of the present disclosure;

FIG. 2 is a schematic cross-sectional view of an example print medium including a base paper substrate and ink-receiving layers on both sides of the base paper substrate in accordance with examples of the present disclosure;

FIG. 3 is a schematic cross-sectional view of an example print medium including a base paper substrate and multiple ink-receiving layers applied to both sides of the base paper substrate in accordance with examples of the present disclosure;

FIG. 4 is a flow diagram representing an example method of making a print medium in accordance with examples of the present disclosure; and

FIG. 5 is a flow diagram representing an example method of printing in accordance with examples of the present disclosure.

### DETAILED DESCRIPTION

In accordance with examples of the present disclosure, an ink-receiving layer can be applied to a base paper substrate to achieve higher gloss, in some examples, when used fora variety of applications, but in one example, in the context of high speed printing, e.g., 100 feet per minute (fpm) or more, 200 fpm or more, 300 fpm or more, etc. In accordance with this and other print media applications, the present disclosure is drawn to print media, methods of making print media, and methods of printing. In one example, a print medium includes a base paper substrate that is cellulose-based, and an ink-receiving layer on the base paper substrate. The ink-receiving layer in this example includes a metal salt, inorganic particulates, a polymeric binder, and an emulsifier. The emulsifier includes a hydroxylated saturated hydrocarbon block including from 6 to 24 carbon atoms and a hydroxyl group and polyalkylene oxide block including from 10 to 35 polyalkylene oxide units selected from polyethylene oxide, polypropylene oxide, or a combination thereof. In one more specific example, the metal salt and the inorganic particulates can be present in the ink-receiving layer at a 1:100 to 1:10 weight ratio. In another example, the polymeric binder comprises a water-soluble polymeric binder and a water-dispersible polymeric binder that are present in the ink-receiving layer at a 1:3 to 1:15 weight ratio. In still another example, the emulsifier and the inorganic particulates can be present in the ink-receiving layer at a 1:150 to 1:10 weight ratio. In further detail, the hydroxylated alkyl group can include a C8 to C20 straight-chained alkyl group with a single terminal hydroxyl group. The polyalkylene oxide can include both polyethylene oxide units and polypropylene oxide units. The inorganic particulates can include both clay particles and calcium carbonate particles, for example. The metal salt can include a multivalent metal salt selected from Group II metal salts, Group III metal salts, transitional metal salts, or combinations thereof. The ink-receiving layer can be present on one or both sides of the base paper substrate, and the ink-receiving layer can have a dry basis weight from 5 gsm to 40 gsm on one or both of the sides. The base paper substrate can have a dry basis weight from 35 gsm to 250 gsm, and can include bleached softwood, hardwood, ground wood fiber, clay, calcined clay, talc, and precipitated or ground calcium carbonate.

In another example, a method of making a print medium includes applying a wet coating composition on a base paper substrate that is cellulose-based, and drying the wet coating composition on the base paper substrate to leave an ink-receiving layer having a dry basis weight of 5 gsm to 40 gsm. The wet coating composition in this example includes water, a metal salt, inorganic particulates, a polymeric binder, and an emulsifier including a hydroxylated saturated hydrocarbon block including from 6 to 24 carbon atoms and a hydroxyl group and polyalkylene oxide block including from 10 to 35 polyalkylene oxide units selected from polyethylene oxide, polypropylene oxide, or a combination thereof. The metal salt and the inorganic particulates can be present in the ink-receiving layer at a 1:100 to 1:10 weight ratio. The emulsifier and the inorganic particulates can be present in the ink-receiving layer at a 1:150 to 1:10 weight ratio. The polymeric binder can be a mixture of a water-soluble polymeric binder and a water-dispersible polymeric binder that are present in the ink-receiving layer at a 1:3 to 1:15 weight ratio. In another example, the hydroxylated saturated hydrocarbon block can include a C8 to C20 straight-chained alkyl group with a single terminal hydroxyl group, and the polyalkylene oxide includes both polyethylene oxide units and polypropylene oxide units.

In another example, a method of printing includes ejecting a pigment-based inkjet ink onto print medium, wherein the print medium comprises a base paper substrate that is cellulose-based and having an ink-receiving layer thereon. The ink-receiving layer in this example includes a metal salt, inorganic particulates, polymeric binders, and an emulsifier including a hydroxylated saturated hydrocarbon block including from 6 to 24 carbon atoms and a hydroxyl group and polyalkylene oxide block including from 10 to 35 polyalkylene oxide units selected from polyethylene oxide, polypropylene oxide, or a combination thereof. In another example, the base paper substrate has a dry basis weight from 35 gsm to 250 gsm and includes bleached softwood, hardwood, ground wood fiber, calcined clay, and precipitated or ground calcium carbonate.

It is noted that when discussing print media, methods of making the print media, or methods of printing, these descriptions can be considered applicable to the other examples, whether or not they are explicitly discussed in the context of that example. Thus, for example, in discussing examples of polyalkylene oxide block in the context of a print medium, such examples can also be applicable to the methods, and vice versa.

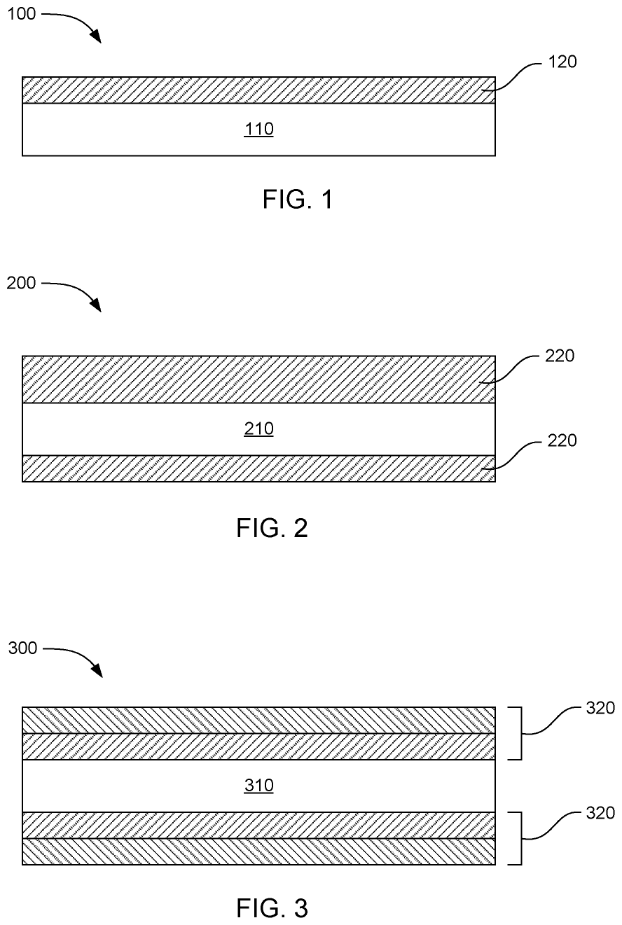

Turning now to the specific components and structures of the print media, several materials have been briefly described and will be described in greater detail hereinafter. FIGS. 1-3 depict example print media that can be prepared in accordance with the present disclosure. FIG. 1 is a print medium 100 with a base paper substrate 110 and an ink-receiving layer 120 on one side of the base paper substrate. FIG. 2 depicts a print medium 200 with a base paper substrate 210 and an ink-receiving layer 220 on both sides of the base paper substrate. In this example, one side of the ink-receiving layer is shown schematically as having a greater basis weight than the other ink-receiving layer. However, it is noted that the two sides of the print medium can have the same or different basis weight. FIG. 3 depicts a print medium 300 with a base paper substrate 310 with a first and a second layer, collectively forming a multi-layered ink-receiving layer 320 on both sides of the base paper substrate. The basis weight of the ink-receiving layers in this example are all the same, but could be different from layer to layer, or different relative to the basis weight of the ink-receiving layer (or sublayer thereof) on the other side. Thus, in one example, there may be multiple ink-receiving layers on one side (but not the other) of a base paper substrate (not shown), or there may be multiple ink-receiving layers on one side of a base paper substrate and on the ink-receiving layer on the other side of the base paper substrate (not show). In still other examples, the base paper substrate can be coated prior to application of the ink-receiving layer, or one side can be coated with an ink-receiving layer and the other side coated with a different composition. FIGS. 1-3 are thus provided for example purposes, but these FIGS. do not represent every combination of base paper substrates and ink-receiving layers, but such other combinations are within the scope of the present disclosure.

The ink-receiving layer can be applied from a coating composition that includes the dry components that are present in the ink-receiving layer, but which are solvated or dispersed in an aqueous liquid carrier as a slurry or formulation of another coating composition viscosity suitable for application to the base paper substrate. The basis weight of the ink-receiving layer can be, for example, from 5 grams per square meter (gsm) to 50 gsm, from 5 gsm to 40 gsm, from 5 gsm to 30 gsm, or from 8 gsm to 25 gsm, or from 10 gsm to 20 gsm per layer per side, for example. If applying multiple layers to a single side, thinner layers can be applied in aggregate to form the ink-receiving layer at a target additive basis weight. For definitional purposes, the basis weight of the ink-receiving layer is the cumulative basis weight of all immediately adjacent layers applied using the same coating compositions. Thus, if two layers are applied from the same coating composition, the basis weight of the ink-receiving layer is the additive basis weight, e.g., application of a 2.5 gsm layer followed by application or another 2.5 gsm layer provides 5 gsm of ink-receiving layer, even though applied using multiple layers. In some instances, by applying multiple layers of coating composition to achieve an ink-receiving layer that was applied by multiple application coatings, this can lead to higher gloss, more complete or more opaque ink-receiving layer coverage (or otherwise improved in some other way), more smoothness, etc. That mentioned, multiple layers may or may not be used in a given application provided the specifications to be reached can be achieved with a single layer, but in many instances, multiple layers can be used for a number of reasons as mentioned.

If the coating compositions used to apply individual layers is different, then that would indicate multiple distinct layers in most instances. The basis weight of the multiple layers applied to a single side, or the basis weight of the ink-receiving layer on one side compared to a second side can be different in basis weight. For example, the coat weight difference can be the same, or it can vary from 0.01 gsm to 20 gsm in basis weight, from 0.1 to 20 gsm in basis weight, from 0.5 to 20 gsm in basis weight, or from 1 gsm to 10 gsm in basis weight. In some examples, after application of one or more layers used to form the ink- receiving layer, the ink-receiving layer can be dried and ready to apply ink thereto, or in some instances, the gloss of the ink-receiving layer can be modified, e.g., usually increased, by calendering using application of heat and pressure, e.g., from 25° C. to 150° C. or from 35° C. to 120° C. and from 50 psi to 3,000 psi or from 500 psi to 2,500 psi, for example.

There are several compositional components in the ink-receiving layer, including a metal salt, inorganic particulates, and polymeric binder. However, in accordance with the present disclosure, the component that can provide some enhanced characteristics related to some enhanced formulation options and coating properties is the emulsifier. In accordance with the present disclosure, the emulsifier includes a hydroxylated saturated hydrocarbon block including from 6 to 24 carbon atoms and a hydroxyl group and polyalkylene oxide block including from 10 to 35 polyalkylene oxide units selected from polyethylene oxide, polypropylene oxide, or a combination thereof. In some examples, the hydroxylated saturated hydrocarbon block can include oligomer from plant or animal source, and thus, can be environmentally-friendly and biodegradable, for example.

As mentioned, the ink-receiving layer can be applied from a coating composition that includes an aqueous liquid carrier and the water dried therefrom (leaving a minimal moisture content, e.g. less than about 6 wt %). Thus, the total content of emulsifier can be characterized based on the dry weight (excluding water) in the ink-receiving layer. For example, the emulsifier can be added to the coating composition and can remain in the dried ink-receiving layer at from 0.05 wt % to 3 wt %, from 0.1 wt % to 2 wt %, or from 0.1 wt % to 1 wt %, for example. In another example, relative to the inorganic particulates that are included in the ink-receiving layer, the emulsifier and the inorganic particulates can be present in the ink-receiving layer at a 1:150 to 1:10 weight ratio, a 1:100 to 1:20 weight ratio, or a 1:75 to 1:25 weight ratio.

The weight average molecular weight of the emulsifier can vary, but in some examples, can be from 500 Mw to 5,000 Mw, from 750 Mw to 4,500 Mw, from 1,000 Mw to 4,000 Mw, from 500 Mw to 4,000 Mw, from 1,000 Mw to 5,000 Mw, or from 1,500 Mw to 3,500 Mw, for example.

The hydroxylated saturated hydrocarbon block can be straight-chained alkyl, branched-alkyl, cycloalkyl, or a combination thereof, for example, but does not include aromatic moieties. Regardless of the hydroxylated saturated carbon block configuration, as mentioned, there can be from 6 to 24 carbons, from 6 to 22 carbons, or from 8 to 20 carbons present in the hydroxylated saturated carbon block. Though the range of 6 to 24 carbons can be effective for use, a range of 8 to 20 carbons in the hydroxylated saturated hydrocarbon block can provide a good block size for aqueous ink applications, as below 8 carbons or so, the effectiveness of emulsification can be slightly compromised. Likewise, up to 20 carbons or so, surface tensions can be retained that can provide a good interface between the ink-receiving layer and aqueous ink compositions that may be printed thereon.

In still further detail, in some specific examples, the hydroxylated saturated carbon block can be hydroxylated with a single hydroxyl group, or can be hydroxylated by multiple hydroxyl groups, e.g., 2 hydroxyl groups, 3 hydroxyl groups, or 4 hydroxyl groups. In one more specific example, the hydroxylated alkyl group can include a C8 to C20 straight-chained alkyl group with a single terminal hydroxyl group, e.g. decanol (C₁₀—OH), dodecanol (C₁₂—OH), tetradecanoe (C₁₄—OH), hexadecanonl (C₁₆—OH), octodecanol (C₁₈—OH), etc. In still further detail, the number of carbon atoms from 6 to 24 can be selected to be an even number of carbon atoms, for example, as fatty alcohols of the present disclosure may typically be made by successive addition of two carbon-units, for example, thus resulting in even numbered carbon chains. That stated, odd-numbered carbon chains can likewise be used prepared by other methods, for example.

In further detail regarding the polyalkylene oxide block, this block can be a homopolymer of polyethylene oxide, a homopolymer of polypropylene oxide, or a hybrid of polyethylene oxide and polypropylene oxide. Thus, in this latter example, the polyalkylene oxide can include both polyethylene oxide units and polypropylene oxide units. Regardless of what type of polyalkylene oxide is used, there can be, for example, from 10 to 50, from 10 to 40, from 15 to 35, or from 15 to 30 polyalkylene oxide units present.

As mentioned, some of the other components that can be present in the ink-receiving layer include metal salts, inorganic particulates, and polymeric binder. The metal salts can be included, for example, for use as a fixative compound in the ink-receiving layer. Fixative compounds, or metal salts in these examples, can provide good image quality when used with aqueous ink compositions. However, metal salts can often lead to lower gloss of the ink-receiving layer as the colorant (of the ink printed thereon) crashes or otherwise interacts with the metal salt. Other components herein can help alleviate this reduced gloss to some degree, and as the metal salt provides good crispness, edge-acuity, and the like, this is a tradeoff that can be worth accepting with appropriate gloss enhancement using other components, such as the emulsifier described herein.

The metal salt can be a multivalent salt, and examples include alkaline earth metals, e.g., calcium or magnesium, as well as any of a number of Group Ill metals, such as copper, nickel, aluminum, etc., combined with an anionic counter ion, which can be chloride, iodide, bromide, nitrate, sulfate, sulfite, phosphate, chlorate, acetate, formate, or other similar counter ions and various combinations thereof. Specific examples thereof include barium chloride, calcium chloride, calcium acetate, calcium nitrate, calcium formate, magnesium chloride, manganese sulfate, magnesium nitrate, magnesium acetate, magnesium formate, zinc chloride, zinc sulfate, zinc nitrate, zinc formate, tin chloride, tin nitrate, manganese chloride, manganese sulfate, manganese nitrate, manganese formate, aluminum sulfate, aluminum nitrate, aluminum chloride, aluminum acetate, or the like. That being described, calcium chloride (CaCl₂) has been found to work particularly well and is a cost effective choice. These metal salts may be used alone or in combinations of two or more. The metal salt concentration in the surface treatment solution can be any functional concentration, but typically is not included in the coating formulation in excess of the critical saturated concentration.

The metal salt can be included in the ink-receiving layer at from 0.5 wt % to 30 wt %, from 1 wt % to 20 wt %, or from 2 wt % to 10 wt %, for example. In another example, relative to the inorganic particulates that are included in the ink-receiving layer, the metal salt and the inorganic particulates can be present in the ink-receiving layer at a 1:100 to 1:10 weight ratio, a 1:75: to 1:15 weight ratio, or a 1:50 to 1:25 weight ratio.

The ink-receiving coating can include inorganic particulates. Inorganic particulates that can be used include any inorganic particulate filler materials, such as precipitated calcium carbonate (PCC), ground calcium carbonate (GCC), clay, titanium dioxide, mica, talc, silica, aluminum silicate, clay (e.g., kaolin clay), boehmite, and/or the like. In one example, the inclusion of precipitated calcium carbonate and/or ground calcium carbonate, either with or without other types of inorganic particulates, has shown enhanced gloss compared to other inorganic particulates. The average particle size of the inorganic particulates can be, for example, from 100 nm to 15 μm, from 200 nm to 10 μm, from 350 nm to 5 μm, or from 500 nm to 2 μm. The inorganic particulates can be included in the ink-receiving layer at a dry basis weight from 60 wt % to 95 wt %, from 70 wt % to 93 wt %, or from 75 wt % to 90 wt %, for example.

The various components in the ink-receiving layer can be bound together and applied to adhere to the base paper substrate due to the presence of polymeric binder. The polymeric binder can be a water-dispersible polymeric binder or a water-soluble polymeric binder. In one example, the polymeric binder can include both water-dispersible polymeric binder and water-soluble polymeric binder. The water-dispersible polymeric binder tends to enhance print durability performance, whereas the water-soluble polymeric binder tends to provide good coating cohesiveness and adherence to the base paper substrate.

One advantage of the use of the emulsifier as described herein is that its presence in the coating composition used to form the ink-receiving layer allows for higher concentrations of water-dispersible polymer, which is better for print durability, including wet durability, relative to the concentrations of the water-soluble polymer that is added. Without this emulsifier, in many instances, water-dispersible polymer and water-soluble polymer could be included in the coating composition at a weight ratio of up to 1:1 or perhaps up to 1:2 with reasonable coating success. With the addition of the emulsifier, water-dispersible polymer to water-soluble polymer can be added at ratios from 3:1 to 15:1, from 3:1 to 12:1, from 3:1 to 10:1, from 3:1 to 8:1, from 5:1 to 15:1, or from 5:1 to 12:1 by weight.

This is helpful because even though the inclusion of a water-soluble binder can provide good coating cohesiveness and other properties, the presence of the water-soluble binder takes up headroom as to the total concentration of other solids that can be present. By reducing the amount of water-soluble binder included to provide good coating properties, other solid components, such as the water-dispersible binder content can be increased, thus providing the opportunity for enhanced print durability.

Example water-soluble binders that can be used include polyvinyl alcohol, casein, soy protein, polysaccharides, cellulose ethers, alginates, starches, polyvinyl pyrrolidone, and/or the like. Example water-dispersible binders that can be used include polymeric latexes such as acrylic latexes, styrene-butadiene latexes, polyvinyl acetate latexes, and copolymers thereof. The water-dispersible binder can be selected, for example, to be stable with the metal salt that is also present in the ink-receiving layer. Additionally, the water-dispersible binder can be selected from any of a number of latex polymers having good binding capability between inorganic fillers and the base paper substrate. To this end, the latex polymer may include copolymers containing carboxyl groups, such as acrylic acids, on macromolecular chains of the latex polymer. This can increase the binding power of the latex by including polar functional groups and stabilize the latex particles through electrostatic repulsion, thus avoiding particle aggregation. On the other hand, latex polymers with some carboxyl groups, but not an overly abundant number of carboxyl groups, can be particularly useful. With too many carboxyl groups, the compatibility of metal salts can be reduced, becoming destabilized by the presence of the metal salts. As a result, latex polymers can be selected by experimentation that have carboxylic acids, but are not present in such abundance that they become destabilized by the metal salts.

Turning now to more detail regarding the base paper substrate, these substrates can include mostly paper fibers made by either using a chemical or mechanical pulping process to yield wood fiber from different types of trees. Chemical pulp, or fibers processed through chemical treatment, can often have better strength and make whiter base media with better light resistance.

Mechanical pulp, or fibers processed using mechanical force, may have weak paper strength, but higher opacity, also tending to turn yellow over time with UV exposure. The different fiber combinations and fiber refining processes can have an impact on the ink-receiving layer designed for digital presses or other printing systems, for example.

The base paper substrate can be an uncoated base stock, or can be a coated base stock, for example. For example, the base paper substrate can be a cellulose base stock made from cellulose fiber pulp. In this example, the cellulose fiber pulp portion can include, for example, from 0 wt % to 30 wt % mechanical pulp, with less than 100 wt % chemical pulp being present as a maximum. In another example, the fiber pulp can include from 30 wt % to 100 wt % mechanical pulp, from 50 wt % to 100 wt % mechanical pulp, from 75 wt % to 100 wt % mechanical pulp, from 90 wt % to 100 wt % mechanical pulp, or with 100 wt % mechanical pulp. One benefit of papers containing mechanical pulp is good opacity, even at low basis weight. Other advantages can include lower cost compared to chemical pulp. Chemical pulp can likewise be used or be present in some examples. Mechanical pulp can be used with chemical pulp with the mechanical pulp having coating layers that may not have as much covering power as other thicker coatings. In some examples, discoloration may not be of a particular concern, and thus, the cheaper option can be chosen. By using some chemical pulp, less yellowing of the base stock may be present, and a whiter and more optically bright coated print medium can be prepared that lasts for a more extended period of time, even with the use of thinner and/or less expensive coatings. However, for certain paper projects, if yellowing or grayer base stock media is not a problem, and other considerations such as cost reduction, etc., are desired, less or no chemical pulp may be present, e.g., newsprint-type publication jobs where the life cycle of the printed products is limited.

In further detail, the base paper substrate can include, for example, a relatively high concentration of wood fiber, including softwood and/or hardwood fiber content. This can in some instances assist in keeping the substrate absorptive. In one example, the softwood fibers can make up the entire wood fiber content, or alternatively, the hardwood fibers can make up the entire wood fiber content. In still other examples, a blend of any proportion of softwood to hardwood can be present, but in one example, the softwood to hardwood range can be from 30:70 to 1:99 by weight. In one specific example, a blend of softwood fiber to hardwood fiber can be from 40:60 to 60:40, or in another example, at about 50:50, by weight. As used herein, the term “wood fiber(s)” refers to cellulosic fibers and other known paper fibers including hardwood pulps and softwood pulps as defined herein. As used herein, the term “hardwood fiber” or “hardwood pulps” refers to fibrous pulp derived from the woody substance of deciduous trees (angiosperms) such as aspen, birch, oak, beech, maple, and eucalyptus. As used herein, the term “softwood fiber” or “softwood pulps” refers to fibrous pulps derived from the woody substance of coniferous trees (gymnosperms) such as varieties of fir, spruce, and pine, as for example loblolly pine, slash pine, Colorado spruce, balsam fir and Douglas fir.

The base paper substrate can also include other additives other than mechanical and/or chemical pulps, such as inorganic filler (similar to the inorganic particulates that may be used in the ink-receiving layer). Examples of inorganic filler may likewise include precipitated calcium carbonate, ground calcium carbonate, clay, talc, titanium dioxide, or some of the inorganic particulates previously mentioned. In some examples, the base paper substrate can include certain types of inorganic fillers, such as clay, precipitated calcium carbonate, ground calcium carbonate, etc. Other additives that may be present in the base paper substrate include internal sizing additives, dry or wet strength agents, dyes, optical brightening agents, etc. In some instances, a small amount of polymeric binder can be used to bind the components together, e.g., from 0.05 wt % to 10 wt % or from 0.1 wt % to 5 wt %.

The base paper substrate can be prepared or selected with lower levels of additives or additives can be selected that allow for good absorption to provide a more open paper structure to receive ink composition through the ink-receiving layer. Internal sizing agents that may be thus used for this purpose include any of those used at the wet end of a paper manufacturing machine and selected to retain the open structure of the base paper substrate. For example, small amounts of rosin; rosin precipitated with alum (Al₂(SO₄)₃); abietic acid and abietic acid homologues such as neoabietic acid and levopimaric acid; stearic acid and stearic acid derivatives; ammonium zirconium carbonate; silicone and silicone-containing compounds; fluorochemicals of the general structure CF₃(CF₂)ₙR , wherein R is anionic, cationic or another functional group and n can range from 1 to 1000; starch and starch derivatives; methyl cellulose;

carboxymethylcellulose (CMC); polyvinyl alcohol; alginates; waxes; wax emulsions; alkylketene dimmer (AKD); alkenyl ketene dimer emulsion (AnKD); alkyl succinic anhydride (ASA); emulsions of ASA or AKD with cationic starch; ASA incorporating alum; and/or other internal sizing agents; and mixtures thereof.

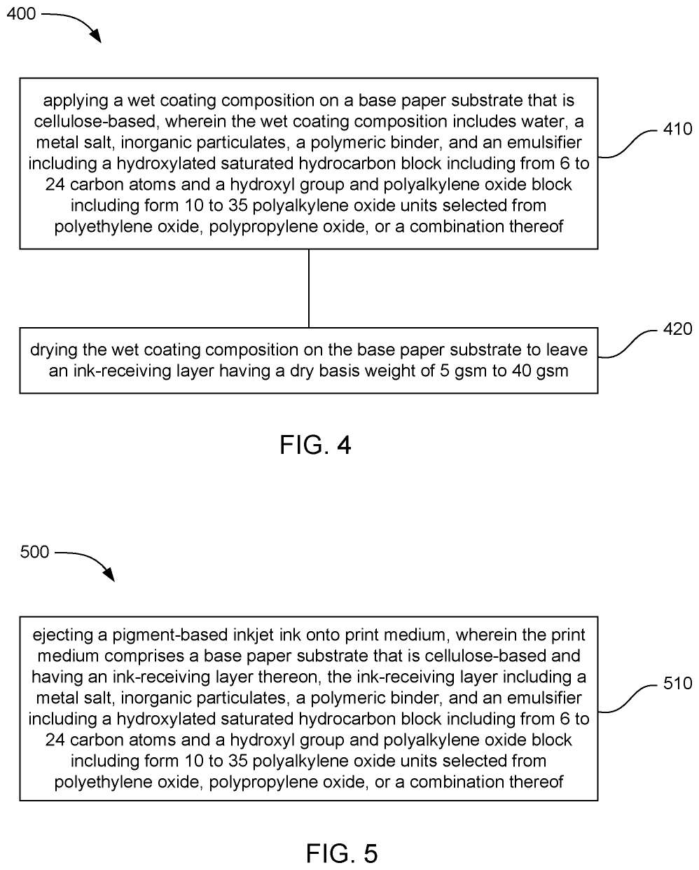

Turning now to FIG. 4, a flow diagram is shown which illustrates an example method of making a print medium 400 in accordance with examples of the present disclosure. The method in this example includes applying 410 a wet coating composition on a base paper substrate that is cellulose-based, and drying 420 the wet coating composition on the base paper substrate to leave an ink-receiving layer having a dry basis weight of 5 gsm to 40 gsm. The wet coating composition in this example includes water, a metal salt, inorganic particulates, a polymeric binder, and an emulsifier including a hydroxylated saturated hydrocarbon block including from 6 to 24 carbon atoms and a hydroxyl group and polyalkylene oxide block including from 10 to 35 polyalkylene oxide units selected from polyethylene oxide, polypropylene oxide, or a combination thereof. The metal salt and the inorganic particulates can be present in the ink-receiving layer at a 1:100 to 1:10 weight ratio. The emulsifier and the inorganic particulates can be present in the ink-receiving layer at a 1:150 to 1:10 weight ratio. The polymeric binder can include a water-soluble polymeric binder and a water-dispersible polymeric binder that are present in the ink-receiving layer at a 1:3 to 1:15 weight ratio. In further detail, any of the various chemical components, coating compositions, ink-receiving layers, base paper substrates, etc., described herein can be used in implementation of this method.

In another example, FIG. 5 provides a flow diagram representing an example method of printing 500 in accordance with examples of the present disclosure. In one example, the method includes ejecting 510 a pigment-based inkjet ink onto a print medium, wherein the print medium comprises a base paper substrate that is cellulose-based and having an ink-receiving layer thereon. The ink-receiving layer in this example includes a metal salt, inorganic particulates, a polymeric binder, and an emulsifier including a hydroxylated saturated hydrocarbon block including from 6 to 24 carbon atoms and a hydroxyl group and polyalkylene oxide block including from 10 to 35 polyalkylene oxide units selected from polyethylene oxide, polypropylene oxide, or a combination thereof. The pigment-based inkjet ink can include latex particles dispersed therein. In further detail, any of the various chemical components, coating compositions, ink-receiving layers, base paper substrates, etc., described herein can be used in implementation of this method.

In further detail, the ink compositions used to print on the print media of the present disclosure can be inkjet ink compositions, such as pigment-based inkjet inks, for example. In some examples, the pigment-based inkjet inks can include a latex binder. In other examples, the colorant of the inkjet ink composition can be a dye, or a combination of pigment and dye. The ink compositions, for example, can be aqueous inkjet ink compositions. In further detail, the ink compositions can be adapted for use in high speed printing applications, using equipment like the HP® PageWide printer or an HP® Web Press printer, e.g., T400 HD series printer, or the like.

It is noted that, as used in this specification and the appended claims, the singular forms “a,” “an,” and “the” include plural referents unless the context clearly dictates otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also to include individual values and sub-ranges within the indicated range. Thus, included in this numerical range are individual values such as 2, 3.5, and 4 and sub-ranges such as from 1-3, from 2-4, and from 3-5, etc. Additionally, a numerical range with a lower end of “0” can include a sub-range using “0.1” as the lower end point.

### EXAMPLES

The following illustrates some examples of various print media and methods associated therewith in accordance with the present disclosure. However, it is to be understood that the following are only examples or are illustrative of applications of the present disclosure. Numerous modifications and alternative coating compositions, base paper substrates, ink-receiving layers, print media, methods, etc. may be devised without departing from the scope of the present technology.

### Example 1—Preparation of Coating Compositions for Applying as an Ink-Receiving Layer on a Base Paper Substrate

The following coating compositions were prepared to evaluate the effectiveness of the block emulsifier of the present disclosure against other emulsifiers. Table 1 provided dry weight percentages of the various components, excluding water. The dry coating composition formulations are provided in Table 1 as follows:

TABLE 1

| | | Coating 1 | Coating 2 | Coating 3 |
|---|---|---|---|---|
| Component | Category | (dry wt%) | (dry wt %) | (dry wt %) |
| Covercarb ® | Inorganic | 52 | 52 | 52 |
| 85 | Particulates | | | |
| Kamin ® | Inorganic | 34.7 | 34.7 | 34.7 |
| 2000C | Particulates | | | |
| Disponil ® | Block | 0.26 | 0.26 | |
| AFX 4030 | Emulsifier | | | |
| Dispex ® | Comparative | — | 0.26 | — |
| N-40V | Emulsifier | | | |
| Litex ® | Water- | 8.7 | 8.7 | 0.87 |
| PX9740 | dispersible | | | |
| | Binder | | | |
| Mowiol ® | Water-soluble | 0.87 | 0.87 | 8.7 |
| 4-98 | Binder | | | |
| CaCL₂ | Metal Salt | 3.47 | 3.47 | 3.47 |

| | |
|---|---|
| Water | Added to Provide Coating Composition with 56 wt % Solids |

Covercarb ® 85 is a ground calcium carbonate available from Omya (USA).
Kamin ® 2000C is a calcined kaolin clay available from Kamin Performance Minerals (USA).
Disponil ® AFX 4030 is an aqueous solution of a modified fatty alcohol polyglycolether available from BASF (Germany), and includes a hydroxylated saturated hydrocarbon block and polyalkylene oxide block in accordance with the present disclosure.
Dispex ® N-40V is an acrylic polymer available from BASF (Germany), and is not a block emulsifier in accordance with the present disclosure.
Litex ® PX9740 is a carboxylated styrene butadiene copolymer available from Synthomer Co. (Great Britain).
Mowiol ® 4-98 is a polyvinyl alcohol available from Sigma-Aldrich (USA).

### Example 2—Preparation of Print Media including Base Paper Substrates and Ink-receiving Layers

The three compositions of Table 1 were prepared for coating on a base paper substrate having a basis weight of 50 gsm and which included 12 wt % precipitated calcium carbonate (PCC) filler. The PCC with these formulations was found to add to overall gloss of the print media. Because Coating 2 was found to be uncoatable on the base paper substrate, Coatings 1 and 3 were applied to base paper substrates at a targeted weight basis of about 10 gsm using a blade coater. The coating compositions were dried on base paper substrates to form an ink-receiving layer that was suitable for printing.

### Example 3—Evaluation of Coating Compositions and Print Media Samples

To the print media samples prepared in accordance with Example 2, an HP® CM8060 MFP web press with A50 inks in the various inkjet pens was used to print sample images using 2 pass and 6 dry spin mode settings. Various evaluative tests were conducted and image quality was observed, as follows:

Coating Processability was determined by viscosity at 56% solids, as determined using a Brookfield rheometer (DV3T) using a 64 spindle at 100 RPM. Formulations with lower viscosities tend to have good processability, while formulations with higher viscosities have poorer processability. With base paper substrates having the weight basis of this example, e.g., 50 gsm, for purposes of this example, formulations with viscosities from greater than 2,500 cP to 4,000 cP at 56 wt % solids are considered Poor, but Coatable, while formulations with viscosities above 4,000 cP at 56 wt % solids may be considered Uncoatable, and viscosities from 50 cP to 2,500 cP may be considered Good for blade coating methods.

Base Paper Permeability was measured using the Parker Print Surf Roughness Tester (Model 58-06) to test Bendtsen permanence. A sample was fed into the detector, where 2000 kPa pressure was applied using air with a hard-backed attachment. The amount of air flow through the sample was then measured.

Bleed and Coalescence (both related to image quality) was checked by printing a black line on a solid yellow color square to see how much ink spread from black line into yellow color. A black line was also printed on a solid blue solid color square to determine the uniformity of the solid blue square after printing the black line thereon. Image quality ratings were based on the following scores: 5-No bleed and no coalescence; 4-Very slight bleed and coalescence; 3-Moderate bleed and coalescence; 2-Significant bleed and coalescence; and 1-Ink flow.

Blue Gloss and Average Gloss (color gloss) was measured using BYK Gardner Gloss Meter at 75° of black, cyan, magenta, yellow, red, green, blue, and the unprinted print media sheet. Blue gloss was used to represent the worst gloss of the various colors, as the high ink density typically leads to lower gloss values.

Wet rub durability was checked visually. Seven strips of color (black, blue, red, green, cyan, magenta, and yellow) were printed at the top of a coated sample. A cloth square was attached to the Taber Linear Abraser tip and wet with deionized water. The cloth covered tip was then placed onto the printed image and moved through each printed line in one motion (25 cycles/min) before being lifted off the sheet. Damage ratings were based on the following scores: 5-No damage; 4-Some ink transfer to cloth; 3-Moderate ink removal and transfer to cloth; 2-Significant ink removal and transfer to cloth; and 1-Full ink removal.

The data collected for these categories is provided in Table 2, as follows:

TABLE 2

| Evaluation | Coating 1 | Coating 2 | Coating 3 |
|---|---|---|---|
| Coating Processability | Good | Uncoatable | Poor, but |
| | | (No Print Media | Coatable |
| | | Samples Prepared) | |
| Base Paper Permeability | 7 | — | 7 |
| (mL/min per gsm) | | | |
| Bleed | 5 | — | 5 |
| Coalescence | 3.5 | — | 3.5 |
| Unprinted Sheet Gloss | 62 | — | 52 |
| Average Printed Gloss | 70 | — | 66 |
| Wet Rub Durability | 4.5 | — | 1 |

As can be seen in Table 2, the use of Dispex® N-40V as the emulsifier (Coating 2) did not generate a coatable formulation. This emulsifier is not a block emulsifier, and includes acrylic polymer. To make a coatable formulation, Disponil® AFX 4030 was used successfully to coat multiple formulations on 50 gsm base paper substrate. Once coated, the ink-receiving layer prepared provided good image quality, high gloss (except for blue gloss in Composition 3), good wet rub durability, and a smooth surface. Comparing Coating Compositions 1 and 3 more specifically, by adding water-dispersible binder and water-soluble binder at a 1:10 weight ratio, a coatable formulation was generated, but coating processability was poor, average gloss was not quite as good, sheet gloss was significantly lower, and there was practically no wet rub durability of the printed image. Conversely, a ratio of water-dispersible binder to water-soluble binder of 10:1 by weight provided a good coating composition formulation with respect to both coating processability, image quality, and wet rub durability. Thus, due in part to the block emulsifier used in accordance with the present disclosure, both Coatings 1 and 3 provided acceptable results, e.g., both were coatable on 50 gsm paper and exhibited good permeability, image quality, and average gloss. However, Coating 1 was better than Coating 3 in forming an ink-receiving layer on a base paper substrate, in terms of coating processabilty, gloss, and wet rub durability.

### Example 4—Alternative Latex Binder

To further evaluate the block emulsifier of Coating 1, two additional coating compositions were prepared (Coating 4 and Coating 5). Coating 4 was identical to Coating 1, except that the same weight percentage of Rovene® 4100 (carboxylated styrene-butadiene emulsion) was used as the latex binder instead of Litex® PX9740. Coating 5 was identical to Coating 4, except that instead of the block emulsifier of the present disclosure, an alternative but similar block emulsifier was selected for use, namely Triton® HW-1000 from Dow (USA). The two formulations are shown in Table 3, as follows:

TABLE 3

| | | Coating 4 | Coating 5 |
|---|---|---|---|
| Component | Category | (dry wt %) | (dry wt %) |
| Covercarb ® | Inorganic Particulates | 52 | 52 |
| 85 | | | |
| Kamin ® | Inorganic Particulates | 34.7 | 34.7 |
| 2000C | | | |
| Disponil ® | Block Emulsifier | 0.26 | — |
| AFX 4030 | | | |
| Triton ® | Comparative Block | — | 0.26 |
| HW-1000 | Emulsifier | | |
| Rovene ® | Water- | 8.7 | 8.7 |
| 4100 | dispersible Binder | | |
| Mowiol ® | Water- | 0.87 | 0.87 |
| 4-98 | soluble Binder | | |
| CaCL₂ | Metal Salt | 3.47 | 3.47 |

| | |
|---|---|
| Water | Added to Provide Coating Composition with 56 wt % Solids |

Covercarb ® 85, Kamin ® 2000C, Disponil ® AFX 4030, and Mowiol ® 4-98 are described at Table 1.
Triton ® HW-1000 is a block emulsifier available from Dow (USA), but is the saturated hydrocarbon block is not hydroxylated.
Rovene ® 4100 is a carboxylated styrene-butadiene emulsion copolymer from mallard Creek Polymers (USA).

These two coating compositions where not coated on base paper substrates to form print media, but were otherwise evaluated for Coating Processability as described in Example 3. Rovene® 4100 has a higher mol % of carboxyl groups per polymer unit than Litex® PX9740, and can have poorer salt stability alone comparatively. Even though Rovene® 4100 has poorer salt stability, the block emulsifier (Disponil® AFX) of the present disclosure was still effective in preparing a coating composition with a coating processability deemed to be coatable, albeit less friendly with respect to coatability compared to the Litex® PX9740 water-dispersible binder. Conversely, by switching out the block emulsifier of Coating 4 of the present disclosure with an alternative emulsifier (Triton® HW-1000) to formulate Coating 5, the coating went from coatable to uncoatable. Though Triton® HW-1000 is a block emulsifier with a saturated hydrocarbon block and a polyethylene oxide block, the hydrocarbon block is branched and is not hydroxylated. Disponil® AFX, on the other hand, includes a straight-chained hydrocarbon chain with a single terminal hydroxyl group. Adding the hydroxyl group as well as using a straight-chained hydrocarbon allowed an otherwise uncoatable coating composition (Coating 5) to be coatable (Coating 4).

While the disclosure has been described with reference to certain examples, those skilled in the art will appreciate that various modifications, changes, omissions, and substitutions can be made without departing from the spirit of the disclosure. It is intended, therefore, that the present disclosure be limited only by the scope of the following claims.

What is claimed is:

1. A print medium, comprising:
a base paper substrate that is cellulose-based; and
an ink-receiving layer on the base paper substrate, the ink-receiving layer including:
a metal salt,
inorganic particulates,
a polymeric binder, and
an emulsifier including a hydroxylated saturated hydrocarbon block including from 6 to 24 carbon atoms and a hydroxyl group and polyalkylene oxide block including form 10 to 35 polyalkylene oxide units selected from polyethylene oxide, polypropylene oxide, or a combination thereof.

2. The print medium of claim 1, wherein the metal salt and the inorganic particulates are present in the ink-receiving layer at a 1:100 to 1:10 weight ratio.

3. The print medium of claim 1, wherein polymeric binder comprises a water-soluble polymeric binder and a water-dispersible polymeric binder that are present in the ink-receiving layer at a 1:3 to 1:15 weight ratio.

4. The print medium of claim 1, wherein the emulsifier and the inorganic particulates are present in the ink-receiving layer at a 1:150 to 1:10 weight ratio.

5. The print medium of claim 1, wherein the hydroxylated saturated hydrocarbon block includes a C8 to C20 straight-chained alkyl group with a single terminal hydroxyl group.

6. The print medium of claim 1, wherein the polyalkylene oxide includes both polyethylene oxide units and polypropylene oxide units.

7. The print medium of claim 1, wherein the inorganic particulates includes both clay particles and calcium carbonate particles.

8. The print medium of claim 1, wherein the metal salt includes a divalent metal salt selected from Group II metal salts, Group III metal salts, transitional metal salts, or combinations thereof.

9. The print medium of claim 1, wherein the base paper substrate has a dry basis weight from 35 gsm to 250 gsm includes bleached softwood, hardwood, ground wood fiber, calcined clay, and precipitated or ground calcium carbonate, and wherein the ink-receiving layer is on one or both sides of the base paper substrate having a dry basis weight from 2.5 gsm to 50 gsm on one side or a dry basis weight on both sides independently from 2.5 gsm to 50 gsm.

10. A method of making a print medium, comprising:
applying a wet coating composition on a base paper substrate that is cellulose-based, wherein the wet coating composition includes water, a metal salt, inorganic particulates, a polymeric binder, and an emulsifier including a hydroxylated saturated hydrocarbon block including from 6 to 24 carbon atoms and a hydroxyl group and polyalkylene oxide block including form 10 to 35 polyalkylene oxide units selected from polyethylene oxide, polypropylene oxide, or a combination thereof; and
drying the wet coating composition on the base paper substrate to leave an ink-receiving layer having a dry basis weight of 5 gsm to 40 gsm.

11. The method of claim 10, wherein the metal salt and the inorganic particulates are present in the ink-receiving layer at a 1:100 to 1:10 weight ratio, and the emulsifier and the inorganic particulates are present in the ink-receiving layer at a 1:150 to 1:10 weight ratio.

12. The method of claim 10, wherein the polymeric binder comprises a water-soluble polymeric binder and a water-dispersible polymeric binder that are present in the ink-receiving layer at a 1:3 to 1:15 weight ratio.

13. The method of claim 10, wherein the hydroxylated saturated hydrocarbon block includes a C8 to C20 straight-chained alkyl group with a single terminal hydroxyl group, and wherein the polyalkylene oxide includes both polyethylene oxide units and polypropylene oxide units.

14. A method of printing, comprising ejecting a pigment-based inkjet ink onto a print medium, wherein the print medium comprises a base paper substrate that is cellulose-based and having an ink-receiving layer thereon, the ink-receiving layer including a metal salt, inorganic particulates, a polymeric binder, and an emulsifier including a hydroxylated saturated hydrocarbon block including from 6 to 24 carbon atoms and a hydroxyl group and polyalkylene oxide block including form 10 to 35 polyalkylene oxide units selected from polyethylene oxide, polypropylene oxide, or a combination thereof.

15. The method of claim 14, wherein the base paper substrate has a dry basis weight from 35 gsm to 250 gsm includes bleached softwood, hardwood, ground wood fiber, calcined clay, and precipitated or ground calcium carbonate.
